(19) United States
(12) Patent Application Publication
(10) Pub. No.: US 2012/0014532 A1
(43) Pub. Date: Jan. 19, 2012

(54) NOISE-CANCELING HEADPHONE

(75) Inventor: Tominori Kimura, Tokyo (JP)

(73) Assignee: Kabushiki Kaisha Audio-Technica, Tokyo (JP)

(21) Appl. No.: 13/180,658

(22) Filed: Jul. 12, 2011

(30) Foreign Application Priority Data
Jul. 15, 2010 (JP) 2010-160991

(51) Int. Cl. G10K 11/16

(52) U.S. Cl. 381/71.6

(57) ABSTRACT

A noise-canceling headphone that cancels external noise with a feedforward system includes a driver unit disposed in a housing, a microphone unit that is outwardly disposed in the housing and collects the external noise, and canceling signal generator that generates a noise-canceling signal having a phase opposite to the noise entering through the headphone. The noise-canceling headphone includes an error detecting microphone unit that detects error noise uncanceled by the feedforward system, and error noise-canceling signal generator that generates an error correction signal to cancel the error noise with a feedback system.

### BACKGROUND OF TUE INVENTION

1. Field of the Invention

The present invention relates to a noise-canceling headphone with a feedback error-signal correction circuit that cancels noise uncanceled by a feedforward noise-canceling headphone.

2. Related Background Art

A noise-canceling headphone analyzes noise collected by a microphone, generates a canceling sound that has an opposite phase to the noise and the same sound level as that of the noise heard by a user through the headphone, and attenuates the noise by canceling the noise with the canceling sound. For example, a noise-canceling headphone having a relatively-close technical idea to the present invention is disclosed in Japanese Unexamined Patent Application Publication No. 2008-99127. The conventional headphone includes a speaker unit driven by a musical sound signal, in which a frame of the speaker unit is driven by a noise-canceling signal generated in response to a noise signal detected by a microphone unit.

As a noise-canceling system, the conventional noise-canceling headphone applies a feedback system, a feedforward system, or a hybrid system that achieves a noise-canceling effect by combining both features of the feedback and feedforward systems. The feedback system, which compresses external noise, can reduce the external noise in a wider frequency band as compared with the feedforward system. The feedforward system can completely cancel the noise in theory if the phase and level of the canceling sound are completely matched with those of the noise.

Trying to ensure the noise-canceling effect in some wide frequency range, the feedforward system disadvantageously reduces the noise-canceling effect at each band. The feedback system disadvantageously causes unstable operation, such as audio feedback in a high frequency band, or depending on the shapes of the user's ears. In the feedback noise-canceling headphone, the quality of reproduction may be degraded due to variation in frequency of a reproduced musical sound. To solve these problems, the sound quality is required to have the same characteristics as the noise-canceling characteristics by preliminarily correcting the sound quality with an active circuit or designing the headphone to obtain a cancelable sound quality. There are, thus, many headphones that cannot be used under the condition that the noise-canceling function is powered off. While the hybrid noise-canceling headphone applying both of the feedforward and feedback systems exerts a better noise-canceling effect, the hybrid noise-canceling headphone has the problem that the sound quality is degraded and audio feedback occurs. There is no noise-canceling headphone that improves the noise-canceling function using the advantages of the feedforward and feedback systems and mutually compensating for their disadvantages.

A general headphone includes an elastic ear pad that comes into contact with the user's ears or temporal regions in order to protect the user's ears. The ring ear pad is disposed on the sound outputting side of a headphone housing. This configuration makes a space defined by a space inside the ring ear pad, a user's ear canal and the headphone housing (referred to as “a front air chamber” in this specification) when the headphone is in use. Even with an outwardly-disposed microphone, the feedforward noise-canceling headphone has difficulty in canceling noise left in the front air chamber.

### SUMMARY OF THE INVENTION

An object of the present invention is to provide a noise-canceling headphone which functions as a headphone even under the condition that a noise-canceling function is powered off, and cancels noise left in a front air chamber.

According to an aspect of the present invention, a noise-canceling headphone that cancels external noise with a feedforward system, includes a housing, a driver unit disposed in the housing, a microphone unit that is outwardly disposed in the housing and collects the external noise, and canceling signal generator that generates a noise-canceling signal having an opposite phase to the noise entering through the headphone. The noise-canceling headphone includes an error or detecting microphone unit that detects error noise uncanceled by the feedforward system, and error noise-canceling signal generator that generates an error correction signal to cancel the error noise with a feedback system.

The noise-canceling headphone according to the present invention cancels, with the feedback system, the noise uncanceled by the feedforward system, so that an excellent noise-canceling effect is achieved. Furthermore, the noise-canceling headphone functions as a headphone even under the condition that the noise-canceling function is powered off.

### BRIEF DESCRIPTION OF THE DRAWINGS

FIG. 1 is a cross sectional view of a noise-canceling headphone according to an embodiment of the present invention;

FIG. 2 is a block diagram of an exemplary controlling system for the noise-canceling headphone according to the present invention;

FIG. 3 is a block diagram of another exemplary controlling system for the noise-canceling headphone according to the present invention;

FIG. 4 is a block diagram of yet another exemplary controlling system for the noise-canceling headphone according to the present invention; and

FIG. 5 is a graph showing results from measurements of noise-canceling performances of the noise-canceling headphone according to the present invention.

### DESCRIPTION OF THE PREFERRED EMBODIMENTS

An embodiment of a noise-canceling headphone according to the present invention is explained below in detail with reference to accompanying drawings.

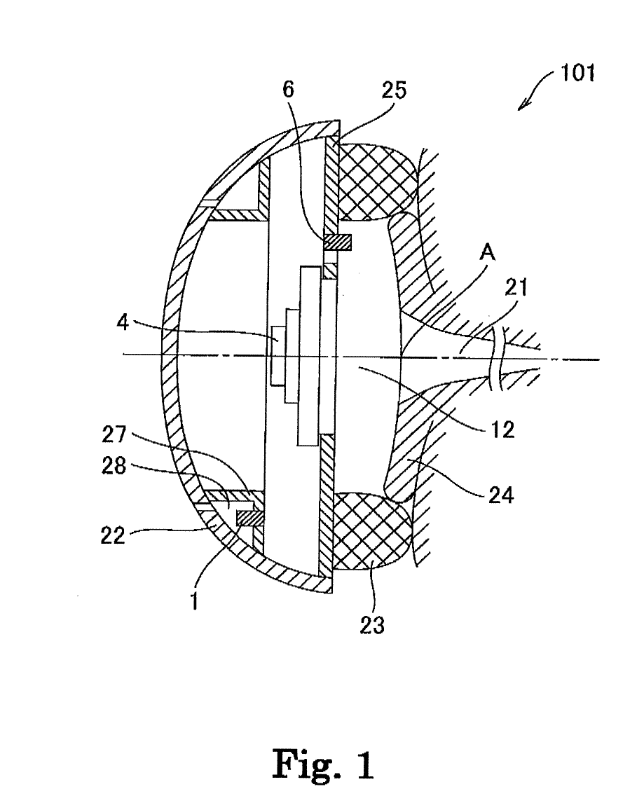

FIG. 1 illustrates a noise-canceling headphone 101 including a housing 22, a driver unit 4 disposed in the housing 22, and a microphone unit 1 outwardly disposed in the housing 22. In common with general headphones, the noise-canceling headphone 101 includes a baffle plate 25 that supports internal components, and an ear pad 23 that is attached along the periphery of one of the surfaces of the baffle plate 25 to cover a user's ear 24.

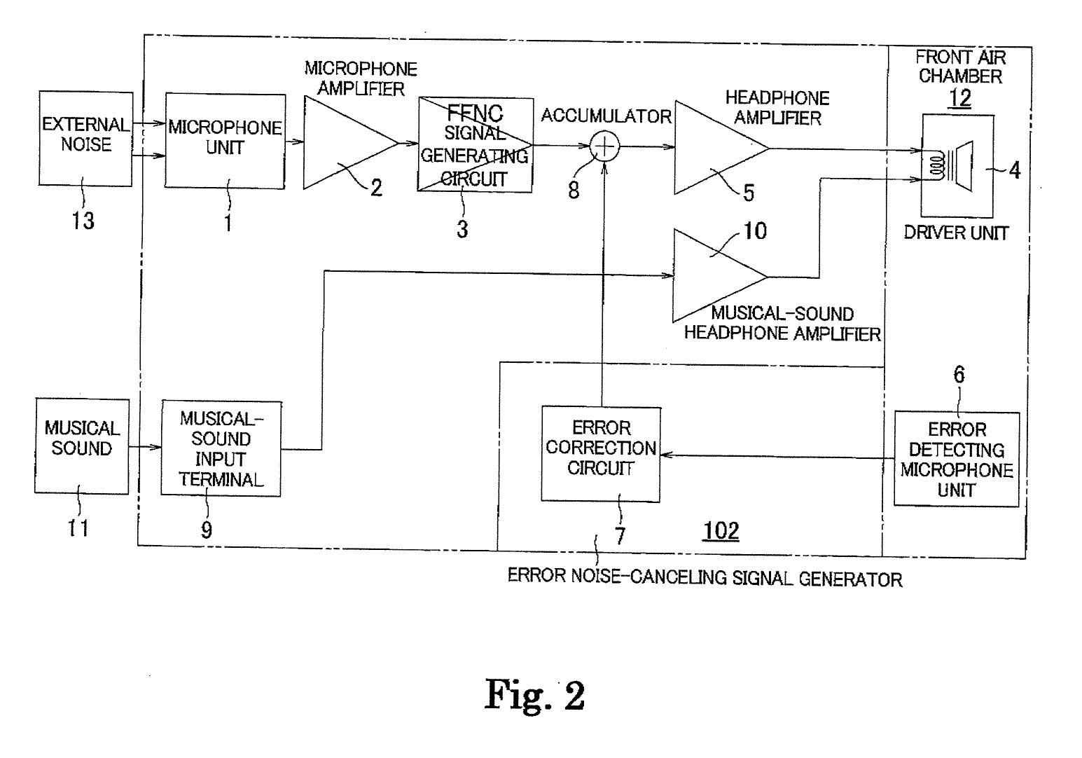

As another structure inside the housing 22 (a back air chamber explained below), the following structures may be added to the above-described structures and structures described below with reference to FIGS. 2 to 4 based on a proper design concept. The housing 22, for example, may contain electronic components, a circuit or a power source therein so as to wirelessly pick up sounds through communication with external equipment. In common with general headphones, the noise-canceling headphone 101 has a pair of right-and-left headphones with a headband interposed therebetween (not shown) so as to cover or be put on the user's ears, For example, like dynamic speakers, the driver unit 4, also called a headphone driver, includes a diaphragm, a voice coil fixed to the diaphragm, a magnetic circuit that drives the voice coil in response to sound signals input to the voice coil, and a frame that supports the magnetic circuit and the outer periphery of the diaphragm.

The driver unit 4 is attached to the center of the back surface of the baffle plate 25 (the left surface in FIG. 1). Sounds are output through a sound outlet hole provided on the center of the baffle plate 25 toward the front surface of the baffle plate 25 by driving the driver unit 4 in response to the sound signals. The sound-output surface of the driver unit 4 is directed to a user's ear canal 21. The bowl-shaped housing 22 is fixed to the back surface of the baffle plate 25 so as to entirely cover the driver unit 4. As illustrated in FIG. 1, the noise-canceling headphone 101 includes the elastic ring ear pad 23 fixed to the front surface of the baffle plate 25 so as to protect the user's ear 24. The noise-canceling headphone 101 is provided, in use, with a space defined by a space surrounded by the ring ear pad 23, the user's ear 24 and the baffle plate 25 (hereinafter, referred to as “a front air chamber 12”). A space defined by the baffle plate 25, the housing 22, and a divider 27 is referred to as “a back air chamber”. As shown in the drawing, the microphone unit 1 is mounted in a space 28 formed by the divider 27 having an L-shaped cross section fixed to the housing 22 and formed in a ring shape along the inner periphery of the housing 22, and the inner surface of the housing 22 such that the microphone unit 1 can collect external noise through a hole formed on the housing 22.

The microphone unit 1 collects the external noise to convert the noise into the sound signal. A noise-canceling signal having a phase opposite to the sound signal is generated based on the sound signal, and combined with a musical sound signal, to thereby drive the driver unit 4. The noise entering the front air chamber 12 is canceled by a reproduced sound of the noise-canceling signal. Accordingly, a user can hear only a reproduced sound of the musical sound signal. The noise-canceling system is referred to as a feedforward system.

An error detecting microphone unit 6 is mounted to the baffle plate 25 such that a sound-pickup part projects into the front air chamber 12 so as to detect error noise uncanceled by the feedforward system in the front air chamber 12.

In FIG. 1, the error detecting microphone unit 6 is positioned adjacent to the ear pad 23 apart from a central axis A of the driver unit 4. This structure allows the error detecting microphone unit 6 to detect the noise uncancelable by the feedforward system, without being directly affected by the musical sound output from the driver unit 4. In response to the detected signal, the noise can be canceled by a feedback system and, therefore, more accurate noise cancellation can be performed. Although any variation in size of the noise-canceling headphone 101 is available in accordance with a proper design concept, the noise-canceling headphone 101 is preferably designed to be large enough for the ear pad 23 to cover the user's ear 24 as shown in the drawing in order to reduce sound leakage. On-ear headphones may be applied.

Next, embodiments of various types of controlling system applied to the noise-canceling headphone according to the present invention are explained below in detail with reference to accompanying block diagrams.

FIG. 2 depicts the noise-canceling headphone including: the microphone unit 1 that detects external noise 13; a microphone amplifier 2 that amplifies the detected signal; a feedforward noise-canceling (hereinafter, abbreviated as FFNC) signal generating circuit 3 that functions as the canceling signal generator and generates the noise-canceling signal having a phase opposite to the signal of noise heard by a user through the headphone; the driver unit 4; a headphone amplifier 5 that drives the driver unit 4; the error detecting microphone unit 6; an error correction circuit 7 that generates an error correction signal in response to the error noise collected by the error detecting microphone unit 6; and an accumulator 8 that adds an FFNC signal to the error correction signal. The noise-canceling headphone also includes a musical-sound input terminal 9 and a musical-sound headphone amplifier 10. The musical-sound input terminal 9 transmits an electric signal reproducing a musical sound 11 or the like to the driver unit 4 through the musical-sound headphone amplifier 10. An output terminal of the headphone amplifier 5 is connected to one terminal of the driver unit 4 while an output terminal of the musical-sound headphone amplifier 10 is connected to the other terminal of the driver unit 4.

The external noise 13 is collected and converted into the electric signal by the microphone unit 1. The electric signal is amplified by the microphone amplifier 2. The amplified electric signal is converted into the FFNC signal by the FFNC signal generating circuit 3 and is input to the accumulator 8. The signal is input from the accumulator 8 to the headphone amplifier 5 and amplified by the headphone amplifier 5. The headphone amplifier 5 drives the driver unit 4 and outputs sound to the front air chamber 12. The output FFNC signal cancels and attenuates, in real time, the noise that enters the front air chamber 12.

Being difficult to completely remove from the front air chamber 12, some noise necessarily remains therein. The noise left inside the front air chamber 12 is collected as an error signal by the error detecting microphone unit 6. The error correction circuit 7 generates the error correction signal. The accumulator 8 adds the FFNC signal to the error correction signal and inputs the added signal to the headphone amplifier 5. The headphone amplifier 5 drives the driver unit 4. The driver unit 4 outputs the canceling sound based on the error correction signal into the front air chamber 12 so as to attenuate the left noise. The error correction circuit 7 here functions as error noise-canceling signal generator 102.

The error detecting microphone unit 6 further detects, as the error signal, the noise attenuated by the error correction signal and attenuates the error signal left in the front air chamber 12 through an operation similar to the above. The error correction circuit 7 operates as a feedback error-signal correction circuit. The musical sound 11 is input from the musical-sound input terminal 9 through the musical-sound headphone amplifier 10 into the driver unit 4. The musical sound 11 output from the driver unit 4 is collected by the error detecting microphone unit 6 and is output from the driver unit 4 through the error correction circuit 7 into the front air chamber 12 again. By virtue of the inherently small amount of output sound, the feedback noise-canceling function has only limited effect on the musical sound 11.

When the controlling system is designed so as to make the error correction signal small enough, it is not necessary to control the sound volume by the musical-sound headphone amplifier 10 in consideration of the external noise 13. Even when controlled, the sound volume requires only a little amount of control, and can be controlled with an extremely simple circuit. Accordingly, a noise-canceling headphone with high sound quality by causing little effect on the original musical-sound quality can be achieved at low cost. As well as the above-explained configuration, a design in which a phase-converted error signal is input into the musical-sound headphone amplifier 10 may also be applied.

In the embodiment of the noise-canceling headphone explained above, the error detecting microphone unit 6 that detects the error noise uncanceled by the feedforward system is disposed in the front air chamber 12, and the error noise-canceling signal generator 102 generates the error correction signal for canceling the error noise and cancels the error noise with the feedback system. The volume to be fed back, therefore, can be reduced, which results in avoidance of audio feedback and variation or degradation of the sound quality. The noise-canceling headphone functions as a headphone even when the noise-canceling function is powered off, that is, when the microphone unit 1 and the error detecting microphone unit 6 in FIG. 1 are powered off.

If the noise is attenuated 20 dB with the feedforward noise-canceling function and the error noise is attenuated 6 dB with the feedback noise-canceling function, a total of −26 dB is canceled. That enables even high external noise to be canceled sufficiently. Although a reproduced musical signal is attenuated 6 dB, the effect on the musical sound 11 is extremely low. In order to achieve these sound canceling characteristics only with the feedback system, a high-performance musical-sound quality correction circuit is required due to attenuation of the musical sound 11 to one twentieth. In contrast, the musical sound 11 is attenuated only to one-half by using the noise-canceling headphone 101 according to the above-explained embodiment. In order to correct the attenuation of the musical sound 11, the amplification degree of the musical-sound headphone amplifier 10 is preferably increased in advance so as to increase the output level of a music player, for example, by about 6 dB as described above. Furthermore, the SN ratio of the musical sound 11 to the external noise is improved by about 6 dB by originally increasing the amplification degree of the musical-sound headphone amplifier 10 only within the frequency bands in which the attenuation occurs. The amount of attenuation of the error noise is preferably approximately from 6 dB to 10 dB.

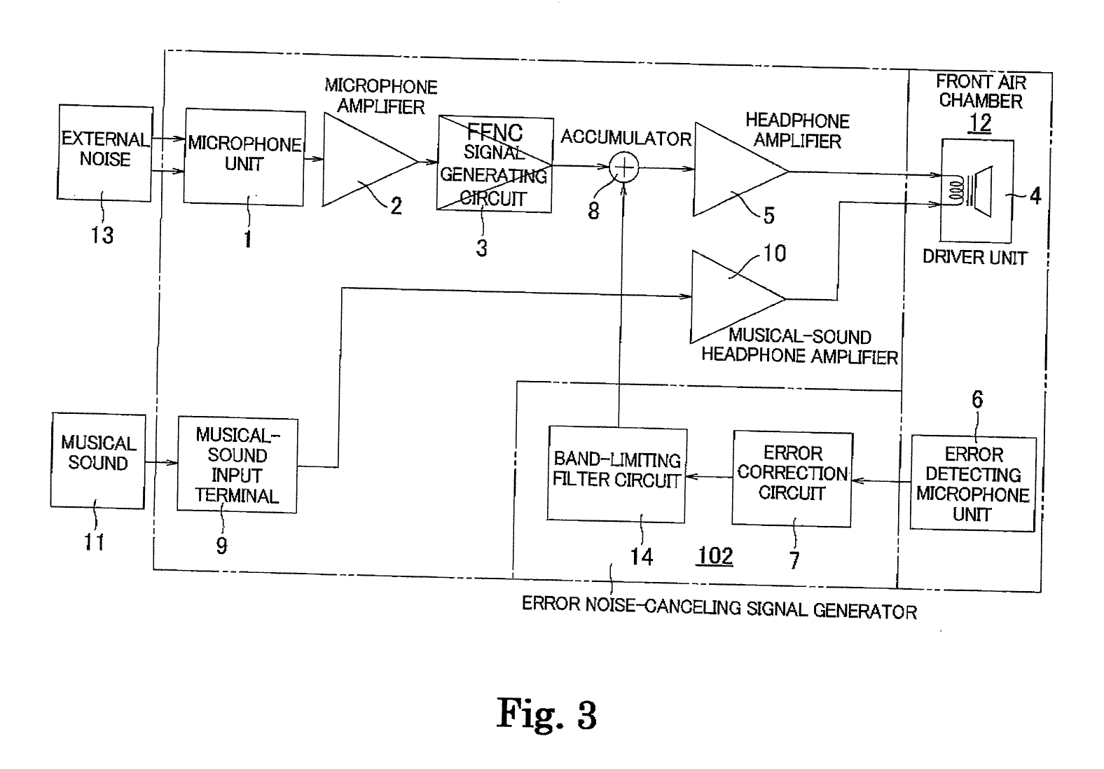

Next, a modified embodiment of the controlling system applicable to the present invention is explained below in detail with reference to FIG. 3.

FIG. 3 illustrates a controlling system of the noise-canceling headphone including a band-limiting filter circuit 14 as a digital filter that is added to the configuration of the error noise-canceling signal generator 102 in the controlling system of the noise-canceling headphone shown in FIG. 2. Although the controlling system of the noise-canceling headphone shown in FIG. 3 is basically similar in structure to that shown in FIG. 2, the controlling system includes the band-limiting filter circuit 14 that transmits only a predetermined frequency through a signal path between the accumulator 8 and the error correction circuit 7. The band-limiting filter circuit 14 may be disposed on a signal transmission circuit between the error detecting microphone unit 6 and the error correction signal generating circuit 7, or interposed between the FFNC signal generating circuit 3 that functions as the canceling signal generator and the accumulator 8 or between the microphone amplifier 2 and the FFNC signal generating circuit 3. A combination of high and low pass filters achieves the band-limiting filter circuit 14.

Since the band-limiting filter circuit 14, thus, limits the frequency band within which the error is corrected with the feedback system, the noise-canceling effect is increased only in a required frequency band, in addition to the above explained effects, to thereby compensate for the disadvantage that the noise-canceling performance is degraded in a wider frequency band, which is the disadvantage of the feedforward error correction. The frequency band within which the error correction is performed with the feedback noise-canceling function is limited and, therefore, the effect on the musical sound 11 is further limited. That is, the noise-canceling performance can be improved by utilizing the features of the feedforward and feedback systems so as to mutually compensate for the disadvantages thereof.

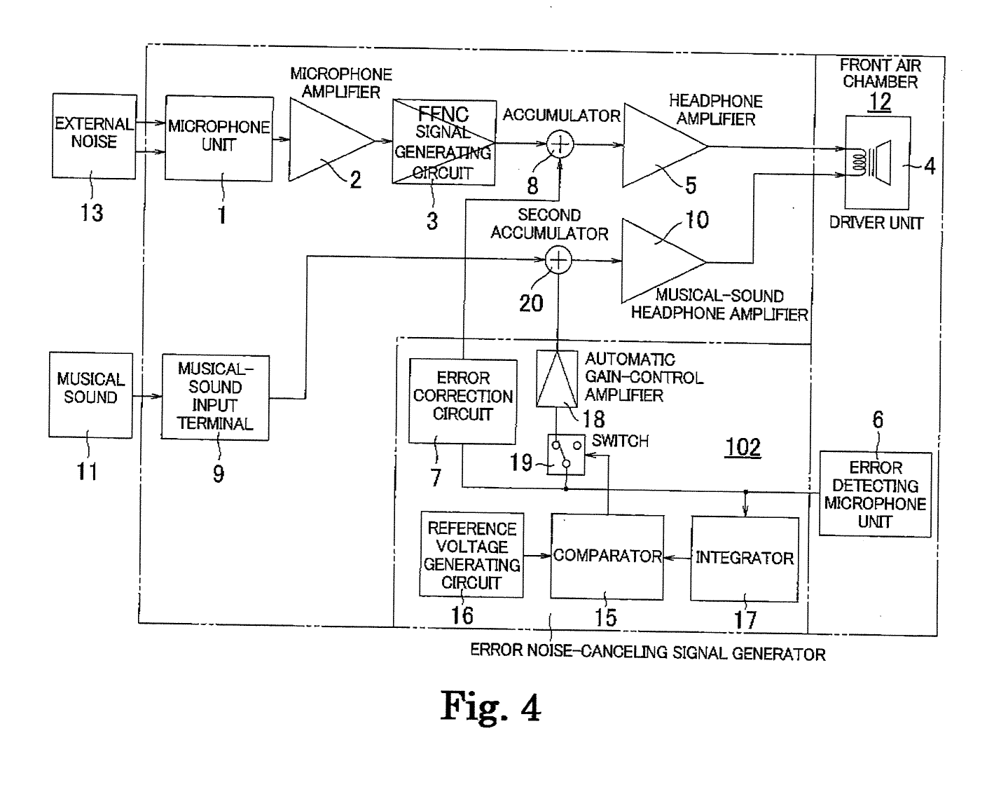

Another modified embodiment of the controlling system applicable to the present invention is explained below with reference to FIG. 4. FIG. 4 illustrates a controlling system of the noise-canceling headphone, including, in addition to the error noise-canceling signal generator 102 in the controlling system of the noise-canceling headphone in FIG. 2: an automatic gain-control amplifier 18; a reference voltage generating circuit 16; a switch 19 that turns on/off the signal output from the error detecting microphone unit 6 into the automatic gain-control amplifier 18; an integrator 17 that integrates the signal output from the error detecting microphone unit 6; a comparator 15 that compares a signal output from the integrator 17 and a signal output from the reference voltage generating circuit 16 and switches the switch 19; and a second accumulator 20 that adds a signal output from the automatic gain-control amplifier 18 to the musical signal.

The error noise-canceling signal generator 102 of the controlling system shown in FIG. 4 operates as follows. A predetermined sound-pressure level of the external noise 13 is determined as a reference sound-pressure level. A voltage corresponding to the reference sound-pressure level is generated as a reference voltage by the reference voltage generating circuit 16. The integrator 17 integrates the output from the error detecting microphone unit 6 and generates a voltage corresponding to the integrated value.

When the integrated value of the integrator 17, that is, the error noise level that is the output level of the error detecting microphone unit 6, is higher than the reference voltage, the switch 19 is turned off. The circuit is configured such that when the switch 19 is turned on, the output from the error detecting microphone unit 6 is input to the automatic gain-control amplifier 18. The comparator 15 compares the voltages output from the integrator 17 and the reference voltage generating circuit 16 respectively. When the voltage output from the integrator 17 is higher than the voltage output from the reference voltage generating circuit 16, the switch 19 is turned off. When the switch 19 is turned off, the output from the error detecting microphone unit 6 to the automatic gain-control amplifier 18 is interrupted. The error correction circuit 7 cancels the noise with the feedback system based on the output from the error detecting microphone unit 6 to correct a cancelation error generated by the feedforward system.

When the value resulting from the integration of the voltage output from the error detecting microphone unit 6 by the integrator 17 is lower than the reference voltage generated by the reference voltage generating circuit 16, the switch 19 is turned on to maintain a constant output level of the error detecting microphone unit 6 by the automatic gain-control amplifier 18. The second accumulator 20 adds the signal of constant level to the signal of the musical sound 11 input through the musical-sound input terminal 9. The added signal is input to the musical-sound headphone amplifier 10. The musical-sound headphone amplifier 10 drives the driver unit 4 in response to the added signal, and the driver unit 4 outputs the musical sound toward the front air chamber 12.

The controlling system in FIG. 4 may further include the band-limiting filter 14 employed in the embodiment shown in FIG. 3.

According to the embodiment shown in FIG. 4 in which the noise-canceling error caused by the feedforward system is corrected with the feedback system, when the sound pressure of the error noise inside the front air chamber 12 is lower than the reference sound pressure level, the canceling error correction with the feedback system can be kept at a constant level. When the sound pressure of the error noise inside the front air chamber 12 is higher than the reference sound pressure level, the level of the canceling error correction with the feedback system is controlled to the level corresponding to the output level of the error detecting microphone unit 6. Accordingly, an excellent noise-canceling effect is achieved.

When the volume of the external noise 13 is small and the sound pressure of the error noise inside the front air chamber 12 is lower than the reference sound pressure level, the level of the canceling error correction with the feedback system is preferably controlled to a level desired by a user, so that the user can hear external sounds. The external sounds, therefore, can be heard without burdensome operation such as taking-off the noise-canceling headphone or powering-off the noise-canceling function.

Any appropriate operation members such as a variable resistor or a switch may be provided so as to optionally control the noise level or the musical sound pressure level.

Furthermore, the reference voltage determined by the reference voltage generating circuit 16 may be controlled by, for example, manual controller.

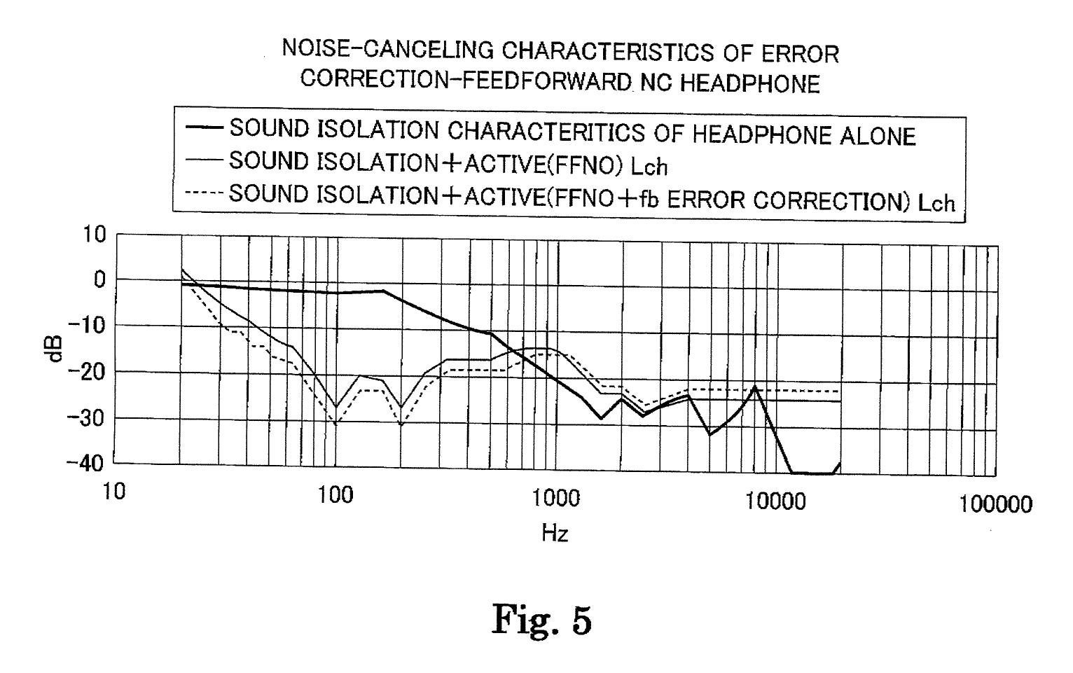

FIG. 5 depicts the noise-canceling characteristics of the noise-canceling headphone according to the present invention.

FIG. 5 is a graph showing the measured noise-canceling characteristics of the noise-canceling headphone 101 having the configuration shown in FIG. 2. In the graph, the horizontal axis represents a frequency range (Hz) and the vertical axis represents a sound pressure (dB). The heavy line represents the sound isolation characteristics of the noise-canceling headphone in the case of powering off the noise-canceling function. The thin line represents the sound isolation characteristics in the case of powering on the canceling signal generator. The dotted line represents the sound isolation characteristics of the noise-canceling headphone in the case of powering on the canceling signal generator and the error noise-canceling signal generator. FIG. 5 shows that the noise-canceling headphone of the present invention achieves effective sound isolation characteristics particularly in the low sound region. By powering on the canceling signal generator and the error noise-canceling signal generator 102, the noise-canceling headphone of the present invention ensures sound-canceling characteristics superior to those of the conventional noise-canceling headphone that cancels noise only by the canceling signal generator.

Although embodiments of the present invention have been explained above, the present invention should not be limited to these embodiments. Other modifications may be made without departing from the scope of the invention as defined in the claims. For example, the noise-canceling headphone of the present invention may be used as an ear muff by increasing a sound isolation function, or a head set provided with a microphone for communication.

What is claimed is:

1. A noise-canceling headphone that cancels external noise with a feedforward system, comprising:
a housing;
a driver unit disposed in the housing;
a microphone unit that is outwardly disposed in the housing and collects the external noise; and
canceling signal generator that generates a noise-canceling signal having a phase opposite to the noise entering through the headphone, wherein
an error detecting microphone unit detects error noise uncanceled by the feedforward system, and
error noise-canceling signal generator generates an error correction signal to cancel the error noise with a feedback system.

2. The noise-canceling headphone according to claim 1, further comprising:
a digital filter that is used for at least one of the canceling signal generator included in the feedforward system and the error noise-canceling signal generator included in the feedback system.

3. The noise-canceling headphone according to claim 1, wherein
the error noise in a limited frequency band is canceled.

4. The noise-canceling headphone according to claim 1, wherein
the error noise-canceling signal generator includes an error correction circuit that generates an error correction signal in response to the error noise collected by the error detecting microphone unit, and a reference voltage generating circuit that determines a predetermined noise level as a reference sound pressure level and generates a reference voltage corresponding to the reference sound pressure level; and
when a voltage output from the error detecting microphone unit is higher than the reference voltage, the error correction circuit functions.

5. The noise-canceling headphone according to claim 4, wherein
the error noise-canceling signal generator includes an automatic gain-control amplifier that maintains a constant output level of the error detecting microphone unit; and
when the voltage output from the error detecting microphone unit is lower than the set reference voltage, the automatic gain-control amplifier functions.

6. The noise-canceling headphone according to claim 4, further comprising:
a switch that is powered off to interrupt a signal output from the error detecting microphone unit to the automatic gain-control amplifier when the voltage output from the error detecting microphone unit is higher than the reference voltage.

7. The noise-canceling headphone according to claim 4, further comprising:
controller that controls the reference voltage generated in the reference voltage generating circuit.

8. The noise-canceling headphone according to claim 1, wherein
the error detecting microphone unit is positioned apart from a central axis of the driver unit.

9. The noise-canceling headphone according to claim 1, wherein
the error detecting microphone unit is disposed in a front air chamber formed between the housing and an ear canal of a user when the noise-canceling headphone is in use.
